(19) United States
(12) Patent Application Publication
(10) Pub. No.: US 2017/0113601 A1
(43) Pub. Date: Apr. 27, 2017

(54) PORTABLE LIGHT ASSEMBLY

(71) Applicant: Ronald McCurdy, Magnolia, TX (US)

(72) Inventor: Ronald McCurdy, Magnolia, TX (US)

(21) Appl. No.: 15/331,618

(22) Filed: Oct. 21, 2016

Related U.S. Application Data
(60) Provisional application No. 62/244,597, filed on Oct. 21, 2015.

(51) Int. Cl. B60Q 1/26; F21V 23/00; F21V 21/22

(52) U.S. Cl. CPC B60Q 1/2661; F21V 21/22; F21V 23/003

(57) ABSTRACT

The present invention provides a portable lighting assembly for attachment to a vehicle for the illumination of a defined area. The assembly includes a mount configured to couple to the hitch of a vehicle. Additionally, a light unit is configured to illuminate the defined area. An extension device is in communication with the mount and configured to elevate and orient the light unit. A power element is configured to supply the light unit with electrical energy. The portable lighting assembly is coupled directly to a vehicle.

### CLAIM OF PRIORITY

This application claims the benefit of U.S. Provisional Application No. 62/4244,597, filed 21 Oct. 2015. The information contained therein is hereby incorporated by reference.

### BACKGROUND

1. Field of the Invention

The present application relates generally to lighting assemblies, and in particular to a portable light assembly carried by a vehicle.

2. Description of Related Art

Various types of industrial and commercial activities occur at night. A large number of these activities occur where there is no permanent fixed lighting devices. It becomes necessary to bring in lighting devices to allow work to be done. Examples of activities where lights may be necessary are: construction at night, working in a field, playing games at night on an unlighted field, and so forth. Fixed lighting is not located everywhere and alternatives for portable lighting are required.

Some portable lighting devices are found in the market. Such lighting units vary in size. They can range from the small scale battery operated ones that are hand operated and hand carried. These may be found in garages and yards of typical suburban homes. Often these are plugged into an outlet on the wall or use replaceable batteries. These portable lights are very limited in their range and cannot provide sufficient light for activities covering a wide area.

In an effort to provide more light, portable light assemblies were made larger. Bigger lights were used which required more energy to run. The lights are typically conventional incandescent lights which needed a lot of energy and produced a considerable amount of heat. Power was provided through the use of a generator. Due to the size of the generator required to run the lights, these units were designed to be pulled behind a vehicle as a standalone trailer unit. Although it may appear convenient, trailers have led to many disadvantages. The ride of a trailer is rough and bouncy. Bulbs tend to break during transport. More maintenance is required for both the trailer and the generator. Additionally, state registration of the trailer is required. When left alone, theft of the trailers can become an issue.

Although great strides have been made with respect to the problem of portable lighting assemblies, considerable shortcomings remain. A new type of portable lighting assembly is needed that reduces costs and lasts longer.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1-2 are perspective views of portable lighting assembly according to a preferred embodiment of the present application;

FIG. 3 is a rear view of the portable lighting assembly of FIG. 1 and 2; and

FIG. 4 is a side view of the portable light assembly of FIG. 1 and 2 fully extended.

While the application is susceptible to various modifications and alternative forms, specific embodiments thereof have been shown by way of example in the drawings and are herein described in detail. It should be understood, however, that the description herein of specific embodiments is not intended to limit the application to the particular forms disclosed, but on the contrary, the intention is to cover all modifications, equivalents, and alternatives falling within the spirit and scope of the application as described herein.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The assembly in accordance with the present application overcomes one or more of the above-discussed problems commonly associated with conventional portable lighting assemblies. Specifically, the assembly of the present application is configured to provide a lighting assembly carried by a vehicle in order to lessen harsh forces experienced through riding on a trailer. The lighting system is configured to expand and collapse in order to adjust the height of the lights. Power is provided through the vehicle wiring and power system by coupling to existing trailer plugs associated on the vehicle. This allows the lights to operate without concern for remote generators. Costs are minimized by removing the need for a generator. These and other unique features of the device are discussed below and illustrated in the accompanying drawings.

The assembly will be understood, both as to its structure and operation, from the accompanying drawings, taken in conjunction with the accompanying description. It should be understood that various components, parts, and features of the device may be combined together and/or interchanged with one another, all of which are within the scope of the present application, even though not all variations and particular embodiments are shown in the drawings. It should also be understood that the mixing and matching of features, elements, and/or functions is expressly contemplated herein so that one of ordinary skill in the art would appreciate from this disclosure that the features, elements, and/or functions of one embodiment may be incorporated into another embodiment as appropriate, unless otherwise described.

The assembly of the present application includes a mount, an extension device, and a lighting unit. The mount coupled to a hitch on a vehicle and is configured to electrically couple to the vehicle power system. The extension device is configured to attach to the mount and selectively elevate and lower the lighting unit. The lighting unit is coupled to an end of the extension device opposite the mount and receives power from the mount and is adjusted to provide light to a particular area.

Referring now to the figures wherein like reference characters identify corresponding or similar elements in form and function. The following Figures describe portable lighting assembly 101 and its associated features.

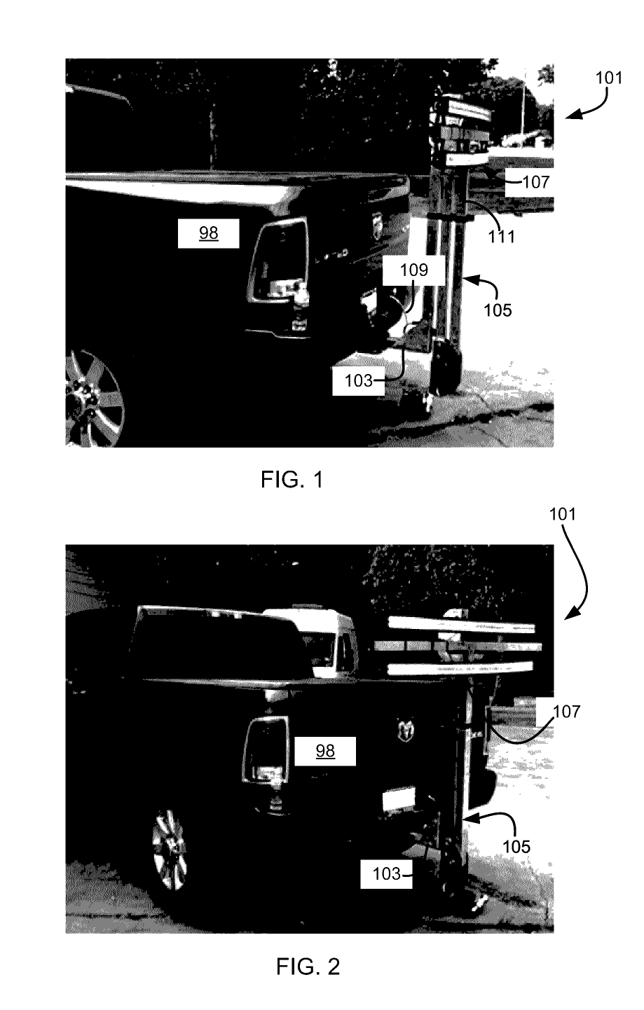

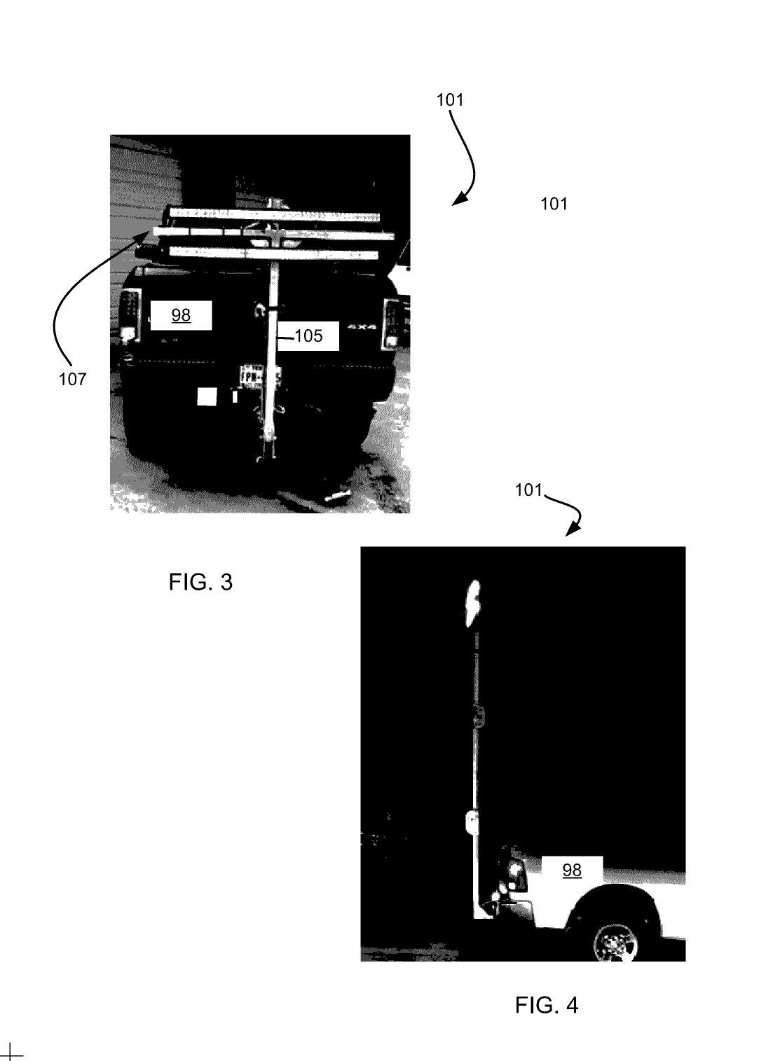

Referring to FIG. 1-4 in the drawings, perspective views and a side view of portable light assembly 101 are illustrated. Vehicle 98 is shown carrying assembly 101. Assembly 101 includes a mount 103, an extension device 105 and a light unit 107. Mount 103 is configure support device 105 and lighting unit 107 by coupling to a hitch secured to vehicle 98. Device 105 extends off mount 103 and selectively locates lighting unit 107. Assembly 101 is configured to be transported off the ground by vehicle 98 without the use of a trailer. The ride quality of vehicle 98 is vastly better than that of a trailer and therefore lessen premature breakage of bulbs associated with lighting unit 107.

Mount 103 is designed in a similar fashion to that of conventional receiver devices used to couple to the hitch. Mount 103 is designed to slide into the hitch and become secured. Pin connections are used for safety and other traditional and conventional methods of securing the receiver end of mount 103 are used. Chains are not necessary since assembly 101 is carried as opposed to being pulled. The opposing end of mount 103 is designed to support the weight and operation of device 105. Mount 103 extends a selected distance away from vehicle 98 to ensure that operation of device 105 does not accidentally damage or contact vehicle 98. Mount 103 may be configured to allow a user to selectively adjust the distance between device 105 and vehicle 98. This could be done through the use of multiple pin holes or a form of telescoping sleeves. Other methods are contemplated herein.

In order to power lighting unit 107, mount 103 further includes a connector 109. Connector 109 extends between lighting unit 107 and vehicle 98. Connector 109 is sized and shaped in one or more conventional manners to fit conventional lighting outlets adjacent to the hitch that are used for the operation of trailers. By connecting connector 109 to the existing wiring of vehicle 98, lighting unit 107 is designed to run without the need for a generator. Weight is thereby reduced. Maintenance is reduced. Extra fuel costs are eliminated. A control module is also included with assembly 101 to allow the user to operate at least lighting unit 107.

Extension device 105 is secured to an end of mount 103 distal from vehicle 98. As mentioned, device 105 is configured to allow the user to selectively elevate lighting unit to one or more positions. The elevation and lowering of lighting unit 107 may be done in many different manners. It is understood that such methods may be automated, powered, or manually operated. FIG. 1-3 illustrate a manual assembly where device 105 includes a plurality of hingedly coupled arms 111 that are designed to pivot about their ends relative to one another. FIG. 4 illustrates a side view of assembly 101 wherein the arms 111 are fully extended relative to one another. One or more arms may be extended to allow intermediate heights for lighting unit 107. The use of arms 111 allows an additional advantage over telescoping methods, such that the arms 111 may be arranged in non-parallel orientations to each other thereby cantilevering lighting unit 107 away from vehicle 98.

Light unit 107 remains coupled to device 105 during times of height adjustment and operation. Light unit 107 includes one or more lights. The lights may be any conventional type, including: halogen, incandescent, CFL, and others to name a few. Ideally, lights requiring minimal power to operate are preferred. Each light is in electrical communication with the power system of vehicle 98. Power is supplied to the lights through operation of the control module. The lights may receive power through a battery of vehicle 98. The vehicle does not have to be running. By running the vehicle while operating assembly 101, charging of the battery may be done simultaneously. Lighting unit 107 is configured to permit the selective adjustment or orientation of lighting unit 107 relative to device 105. Lighting unit 107 may include any number of pivoting apparatuses, swivels, or tilting mechanisms to orient the lights.

It is desired that the construction of light assembly 101 is done with light weight and strong materials to permit a single user to lift it and insert it into the hitch. Mount 103 is able to be sized to fit a particular hitch size (Class I, Class II, Class III, Class IV, etc. . . . ). An adapter may also be included within system 101 to allow system 101 to be swapped between different sized hitches.

In operation, system 101 is lifted and inserted into the hitch on vehicle 98. The use of the adapter is optional. System 101 is secured as necessary. Vehicle 98 is then driven to a desired location, being carried by the hitch on the vehicle. Light unit 107 is elevated to the necessary height and the lights are operated as needed. Lights may be turned on during driving. Another feature of system 101 is the ability for the control module to be mounted internally to vehicle 98 to allow the user to control and operate system 101 from inside the vehicle.

Assembly 101 includes a number of advantages, such as at least the following: 1) minimized vibration during travel due to increased ride quality of the vehicle; 2) lower repair costs; 3) decreased maintenance; 4) longer operational time; 5) optional control within the cab of the vehicle to adjust lights, power lights, and/or operate the extension device from inside the vehicle and even while driving; and 6) powered through the trailer pin connectors associated with the hitch. Other feature exist and are clear from the description of assembly 101.

It is evident by the foregoing description that the subject application has other significant benefits and advantages. The present system is amenable to various changes and modifications without departing from the spirit thereof. The particular embodiments disclosed above are illustrative only, as the apparatus may be modified and practiced in different but equivalent manners apparent to those skilled in the art having the benefit of the teachings herein. It is therefore evident any alterations, modifications, and all such variations are considered within the scope and spirit of the application. It is apparent that an apparatus with significant advantages has been described and illustrated.

What is claimed is:

1. A portable light assembly, comprising:
a mount configured to couple to the hitch of a vehicle;
a light unit configured to illuminate a defined area;
an extension device in communication with the mount and configured to elevate and orient the light unit; and
a power element configured to supply the light unit with electrical energy;
Wherein the mount elevates the light unit off the ground.
